(19) United States
(12) Patent Application Publication
(10) Pub. No.: US 2007/0001934 A1
(43) Pub. Date: Jan. 4, 2007

(54) Plasma display apparatus and driving method thereof

(75) Inventor: Seonghak Moon, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 11/478,132

(22) Filed: Jun. 30, 2006

(30) Foreign Application Priority Data
Jul. 1, 2005 (KR) 10-2005-0059412

(51) Int. Cl. G09G 3/28

(52) U.S. Cl. 345/68

(57) ABSTRACT

This document relates to a display apparatus, and more particularly, to a plasma display apparatus and a driving method thereof, in which an amount of a driving voltage can be controlled depending on driving conditions of the plasma display apparatus, thereby improving driving characteristics.

This Non-provisional application claims priority under 35 U.S.C. § 119(a) on Patent Application No. 10-2005-0059412 filed in Korea on Jul. 1, 2005 the entire contents of which are hereby incorporated by reference.

### BACKGROUND

1. Field of the Invention

The present invention relates generally to a display apparatus, and more particularly, to a plasma display apparatus and a driving method thereof.

2. Description of Background Art

A plasma display apparatus generally comprises a plasma display panel for displaying an image and a driver for driving the plasma display panel. The driver is formed on a rear surface of the plasma display panel.

In general, a plasma display panel has a front panel and a rear panel. A barrier rib formed between the front panel and the rear panel forms one unit discharge cell. Each cell is filled with an inert gas containing a primary discharge gas, such as neon (Ne), helium (He) or a mixed gas of Ne+He, and a small amount of xenon (Xe). A plurality of the unit discharge cells form one pixel. For example, a red (R) cell, a green (G) cell, and a blue (B) cell may form one pixel.

When the unit discharge cell is applied with a high frequency voltage and thus discharged, the inert gas generates vacuum ultraviolet rays. Phosphors formed between the barrier ribs are excited to display images.

The plasma display panel comprises a plurality of electrodes, such as a scan electrode Y, a sustain electrode Z, and an address electrode X. To the electrodes of the plasma display panel are connected drivers for supplying a driving voltage to the electrodes.

When the plasma display panel is driven, the respective drivers supply the electrodes of the plasma display panel with a reset pulse in a reset period, a scan pulse in an address period, and a driving pulse, such as a sustain pulse, in a sustain period, thereby implementing images. The plasma display panel constructed above can be made thin and light, and has thus been in the spotlight as the next-generation display devices.

Meanwhile, the reliability of driving may be degraded due to several causes in driving the plasma display apparatus by supplying the pulses to the electrodes.

For example, there are several problems upon high-voltage driving, such as when both a positive voltage and a negative voltage are supplied. The production cost may also rise due to the use of an element with a high withstanding voltage. Furthermore, not only a voltage source for supplying voltages, but the circuit are complicated. This results in driving instability.

Furthermore, electrical influence between the electrodes when a voltage is applied may not only have an adverse effect on the driving of the plasma display apparatus, but also damage the plasma display apparatus. For example, when a pulse is applied to the scan electrode and the sustain electrode to generate a discharge, the noise of an impulse current component may be introduced into the address electrode and damage constituent elements connected to the address electrode.

Research for improving the driving stability of the plasma display apparatus considering the above-mentioned problems has been in progress.

### SUMMARY OF THE INVENTION

Accordingly, an object of the present invention is to solve at least the problems and disadvantages of the background art.

A plasma display apparatus a first embodiment of the present invention comprises a plasma display panel comprising an address electrode, a scan electrode, and a sustain electrode; a scan driver for supplying a driving voltage that is less than a first base voltage to the scan electrode in a subfield period; a sustain driver for supplying a driving voltage that is less than a second base voltage to the sustain electrode in the subfield period; and a data driver for supplying a voltage of a data pulse, which is more than a third base voltage, to the address electrode, wherein the first base voltage and the second base voltage are less than the voltage of the data pulse.

A plasma display apparatus a second embodiment of the present invention comprises a plasma display panel comprising an address electrode, a scan electrode, and a sustain electrode; a scan driver for ensuring that all of the driving pulses applied to the scan electrode in a subfield period have a negative polarity; a sustain driver for ensuring that all of the driving pulses applied to the sustain electrode in the subfield period have a negative polarity; and a data driver for supplying a voltage of a data pulse, which has a positive polarity, to the address electrode.

A method of driving a plasma display apparatus according to a third embodiment of the present invention comprises the steps of supplying a first set-down pulse gradually falling from a first base voltage and a scan pulse falling from a scan reference voltage less than the first base voltage, to a scan electrode, and supplying a sustain pulse, which falls from a first sustain base voltage, which is equal to the first base voltage, or rises from a second sustain base voltage less than the scan reference voltage to the first base voltage, to the scan electrode; supplying a second set-down pulse before the first set-down pulse is supplied to the scan electrode, which falls from a second base voltage, to the sustain electrode, and supplying a sustain pulse, which falls from the first sustain base voltage, which is equal to a second base voltage, or rises from the second sustain base voltage less than the second base voltage to the second base voltage, to the sustain electrode; and supplying a voltage of a data pulse, which rises from a third reference voltage, to an address electrode while the scan pulse is supplied to the scan electrode.

### BRIEF DESCRIPTION OF THE DRAWINGS

The embodiment of the invention will be described in detail with reference to the following drawings in which like numerals refer to like elements.

FIG. 1 is a block diagram showing the construction of a plasma display apparatus according to an embodiment of the present invention;

FIG. 2 is a view illustrating an example of a method of implementing image gray levels of a plasma display apparatus according to an embodiment of the present invention;

FIG. 3 is a circuit diagram of a driver of the plasma display apparatus according to an embodiment of the present invention;

FIG. 4 is a first embodiment of a driving waveform of the plasma display apparatus according to the present invention; and

FIG. 5 is a second embodiment of a driving waveform of the plasma display apparatus according to the present invention.

### DETAILED DESCRIPTION OF PREFERRED EMBODIMENTS

Preferred embodiments of the present invention will be described in a more detailed manner with reference to the drawings.

A plasma display apparatus a first embodiment of the present invention comprises a plasma display panel comprising an address electrode, a scan electrode, and a sustain electrode; a scan driver for supplying a driving voltage that is less than a first base voltage to the scan electrode in a subfield period; a sustain driver for supplying a driving voltage that is less than a second base voltage to the sustain electrode in the subfield period; and a data driver for supplying a voltage of a data pulse, which is more than a third base voltage, to the address electrode, wherein the first base voltage and the second base voltage are less than the voltage of the data pulse.

The subfield period comprises a reset period, an address period, and a sustain period.

The driving voltage supplied to the scan electrode by the scan driver comprises a voltage of a first set-down pulse, which gradually falls from the first base voltage, in a reset period, a scan reference voltage maintained at a constant level in an address period, a voltage of a scan pulse, which falls from the scan reference voltage level, in the address period, and a voltage of a sustain pulse supplied in a sustain period.

The driving voltage supplied to the sustain electrode by the sustain driver comprises a second set-down voltage falling from the second base voltage in a reset period, and a sustain voltage.

The scan driver and the sustain driver alternately supply sustain pulses, the sustain pulses supplied by the scan driver fall from the first base voltage and the sustain pulses supplied by the sustain driver fall from the second base voltage, in a sustain period.

The scan driver and the sustain driver alternately supply sustain pulses, which rise from a voltage having a level less than the first base voltage and the second base voltage to the first base voltage and the second base voltage, in a sustain period.

The first base voltage and the second base voltage are less than or equal to the third base voltage.

The voltage levels of the first base voltage, the second base voltage, and the third base voltage are equal to each other.

A plasma display apparatus a second embodiment of the present invention comprises a plasma display panel comprising an address electrode, a scan electrode, and a sustain electrode; a scan driver for ensuring that all of the driving pulses applied to the scan electrode in a subfield period have a negative polarity; a sustain driver for ensuring that all of the driving pulses applied to the sustain electrode in the subfield period have a negative polarity; and a data driver for supplying a voltage of a data pulse, which has a positive polarity, to the address electrode.

A driving voltage for supplying the negative pulse supplied to the scan electrode by the scan driver comprises a voltage of a first set-down pulse, which gradually falls from a first base voltage, in a reset period, a scan reference voltage maintained at a constant level less than the first base voltage in an address period, and a voltage of a scan pulse, which falls from the scan reference voltage level, in the address period. A driving voltage for supplying the negative pulse supplied to the sustain electrode by the sustain driver comprises a voltage of a second set-down pulse, which falls from a second base voltage, in the reset period.

The scan driver and the sustain driver alternately supply sustain pulses, the sustain pulses supplied by the scan driver fall from the first base voltage and the sustain pulses supplied by the sustain driver fall from the second base voltage, in a sustain period.

The scan driver and the sustain driver alternately supply sustain pulses, which rise from a voltage level less than that of the first base voltage and the second base voltage to the first base voltage and the second base voltage, in a sustain period.

The first base voltage, the second base voltage, and the third base voltage equal a ground level voltage.

The scan driver comprises a first set-down voltage supply unit for supplying a ramp-down waveform, which falls from the first base voltage to a first set-down voltage of a negative polarity at a predetermined slope, to the scan electrode; a scan voltage supply unit connected parallel to the first set-down voltage supply unit, for supplying the scan voltage to the scan electrode; a first sustain pulse supply unit connected parallel to the first set-down voltage supply unit and the scan voltage supply unit, for supplying a sustain voltage to the scan electrode; and a scan reference voltage supply unit connected parallel to the first set-down voltage supply unit and the scan voltage supply unit, for supplying the scan reference voltage to the scan electrode.

The first sustain pulse supply unit comprises a first base voltage supply unit for supplying the first base voltage to the scan electrode; and a first sustain voltage supply unit for supplying the sustain voltage to the scan electrode.

The sustain driver comprises a second set-down voltage supply unit for supplying a second set-down voltage to the sustain electrode; and a second sustain pulse supply unit connected parallel to the second set-down voltage supply unit, for supplying a sustain voltage and a second base voltage to the sustain electrode.

A method of driving a plasma display apparatus according to a third embodiment of the present invention comprises the steps of supplying a first set-down pulse gradually falling from a first base voltage and a scan pulse falling from a scan reference voltage less than the first base voltage, to a scan electrode, and supplying a sustain pulse, which falls from a first sustain base voltage which is equal to the first base voltage, or rises from a second sustain base voltage less than the scan reference voltage to the first base voltage, to the scan electrode; supplying a second set-down pulse before the first set-down pulse is supplied to the scan electrode, which falls from a second base voltage, to the sustain electrode, and supplying a sustain pulse, which falls from the first sustain base voltage, which is equal to a second base voltage, or rises from the second sustain base voltage less than the second base voltage to the second base voltage, to the sustain electrode; and supplying a voltage of a data pulse, which rises from a third reference voltage, to an address electrode while the scan pulse is supplied to the scan electrode.

The second set-down pulse comprises a gradually falling pulse.

The first base voltage and the second base voltage are less than or equal to the third base voltage.

The first base voltage, the second base voltage, and the third base voltage equal a ground level voltage.

An embodiment of the present invention will be described below with reference to the accompanying drawing.

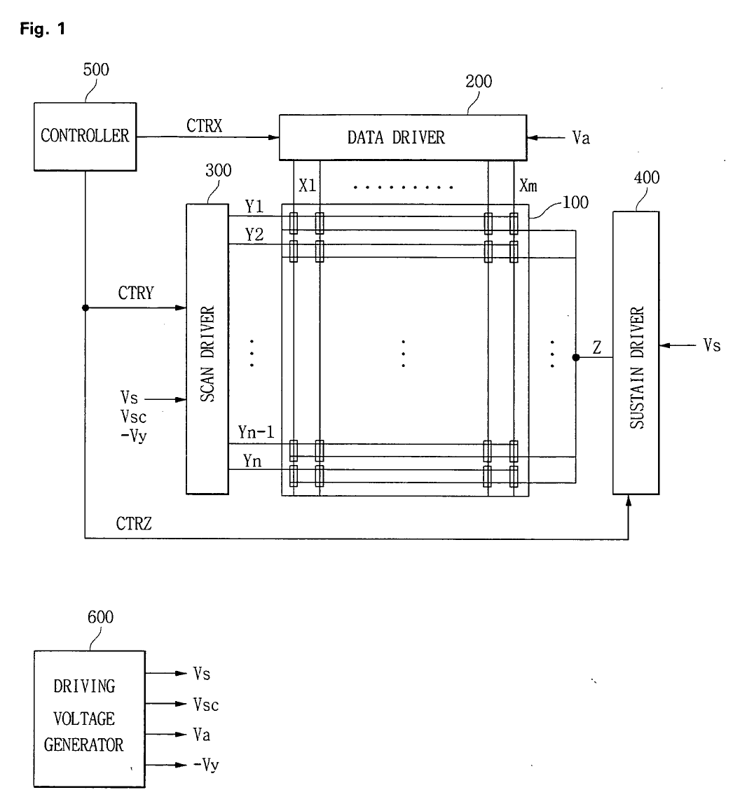

FIG. 1 is a block diagram showing the construction of a plasma display apparatus according to an embodiment of the present invention.

As shown in FIG. 1, the plasma display apparatus according to an embodiment of the present invention comprises a plasma display panel 100 for processing externally input picture data and displaying an image, a data driver 200 for supplying data to address electrodes X1 to Xm formed in the plasma display panel 100, a scan driver 300 for driving scan electrodes Y1 to Yn, a sustain driver 400 for driving sustain electrodes Z (i.e., common electrode), a controller 500 for controlling the respective drivers, and a driving voltage generator 600 for supplying driving voltages required for the respective drivers 200, 300, and 400.

To help understand the present invention, an example of a driving method of the plasma display apparatus will be described below in short.

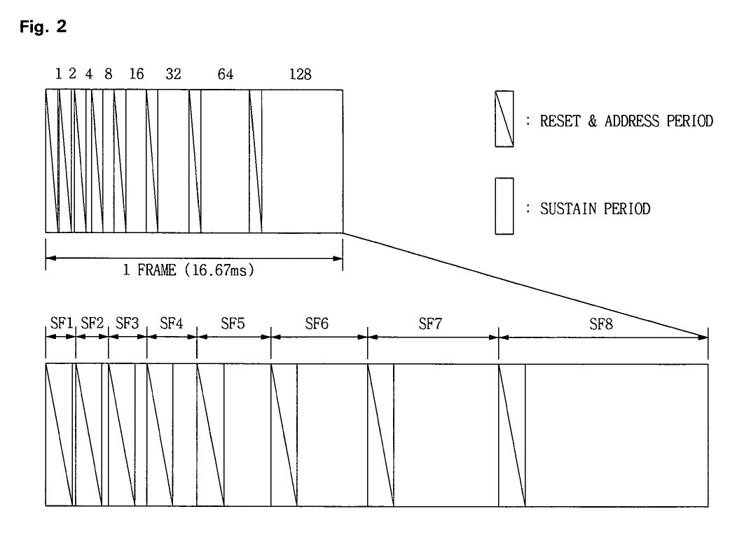

FIG. 2 is a view illustrating an example of a method of implementing image gray levels of a plasma display apparatus according to an embodiment of the present invention.

Referring to FIG. 2, to implement an image on the plasma display panel, the plasma display apparatus of the present invention may be driven with one frame being divided into a plurality of subfields. That is, the plasma display apparatus may be driven with each subfield being divided into a reset period for resetting the entire cells, an address period for selecting cells to be discharged, and a sustain period for implementing gray levels depending on a discharge number.

For example, if it is sought to display images with 256 gray levels, a frame period (16.67 ms) corresponding to 1/60 seconds is divided into eight subfields SF1 to SF8. Each of the eight subfields SF1 to SF8 is divided into a reset period (RP), an address period (AP), and a sustain period (SP), as described above. The reset period (RP) and the address period (AP) of each subfield are the same every subfield, whereas the sustain period and the number of sustain signals allocated thereto are increased in the ratio of 2ⁿ (where n=0, 1, 2, 3, 4, 5, 6, 7) in each subfield. Since the sustain period is different in each subfield as described above, gray levels of an image are represented by controlling the sustain period of each subfield (i.e., a sustain discharge number).

Hereinafter, the plasma display apparatus according to an embodiment of the present invention will be described with reference to FIG. 1.

The plasma display apparatus according to an embodiment of the present invention shown in FIG. 1 comprises the plasma display panel 100, a controller 500 for controlling the drivers 200, 300, and 400 and the respective drivers, and a driving voltage generator 600.

The plasma display panel 100 comprises a front substrate (not shown) and a rear substrate (not shown), which are coalesced with a predetermined gap therebetween. A number of electrodes, such as the scan electrodes Y1 to Yn and the sustain electrodes Z, are formed in pairs in the front substrate. The address electrodes X1 to Xm are formed to cross the scan electrodes Y1 to Yn and the sustain electrodes Z in the rear substrate.

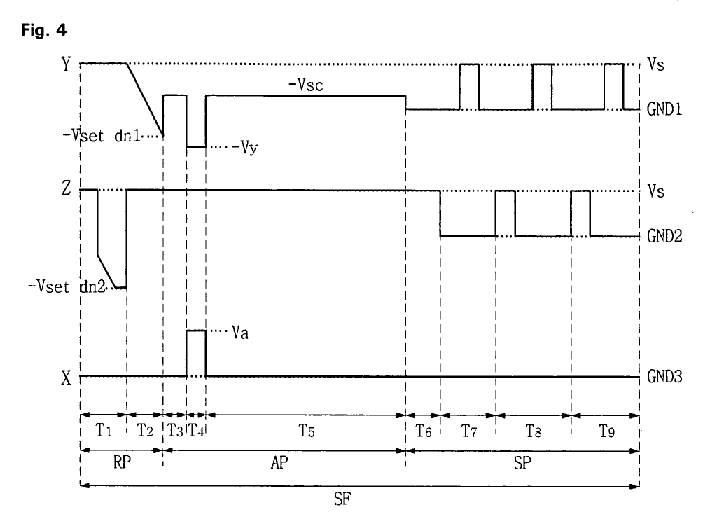

The data driver 200 is supplied with data, which have experienced inverse gamma correction, error diffusion, and so on through an inverse gamma correction circuit (not shown), an error diffusion circuit (not shown), and so on and been then mapped to respective sub-fields by a sub-field mapping circuit. The data driver 200 samples and latches data under the control of the controller 500 and supplies a voltage of a data pulse to the address electrodes X1 to Xm according to the data. For example, the voltage of the data pulse may have a level greater than that of a third base voltage. This will be described in detail later on with reference to FIG. 4.

The scan driver 300 applies a reset waveform to the scan electrodes Y1 to Yn during the reset period under the control of the controller 600, thus resetting discharge cells corresponding to the whole screen. For example, the discharge cells can be reset by supplying a voltage of a first set-down pulse that gradually falls from a first base voltage.

After supplying the reset waveform to the scan electrodes Y1 to Yn, the scan driver 300 supplies a scan reference voltage Vsc less than the first base voltage and a voltage of a scan pulse that falls from the scan reference voltage Vsc to a negative level, to the scan electrodes Y1 to Yn, during the address period, thereby scanning scan electrode lines.

Furthermore, the scan driver 300 supplies a sustain pulse, which can cause a sustain discharge in cells selected in the address period, to the scan electrodes Y1 to Yn during the sustain period. For example, a sustain pulse having a level less than that of the first base voltage may be supplied to the scan electrodes. This and a variety of embodiments thereof will be described later on with reference to FIG. 4.

The sustain driver 400 supplies a voltage of a second set-down pulse to the sustain electrode Z during the reset period and then supplies a sustain pulse to the sustain electrode Z while alternately operating with the scan driver 300 during the sustain period, under the control of the timing controller 16. For example, a sustain pulse having a level less than that of the first base voltage may be applied to the sustain electrodes. This and a variety of embodiments thereof will be described later on with reference to FIG. 4.

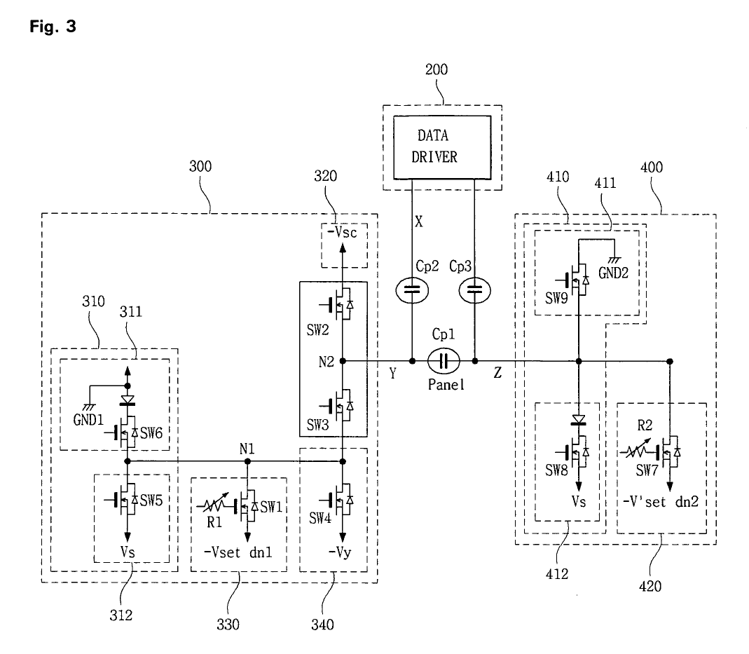

As described above, the data driver 200 supplies a voltage of a data pulse, which is more than the third base voltage. The scan driver 300 supplies a driving voltage less than the first base voltage. The sustain driver 400 supplies a driving voltage less than the second base voltage. Unlike the related art, in an embodiment of the present invention, the first base voltage and the second base voltage are less than the voltage of the data pulse. This will be described in detail later on with reference to FIG. 3.

The controller 500 receives vertical/horizontal sync signals, generates timing control signals CTRX, CTRY, and CTRZ required for the respective drivers, and supplies the generated timing control signals CTRX, CTRY, and CTRZ to corresponding drivers 200, 300, and 400, thus controlling the respective drivers 200, 300, and 400. The data control signal CTRX supplied to the data driver 13 comprises a sampling clock for sampling data, a latch control signal, and a switching control signal for controlling an on/off time of an energy recovery circuit and a driving switch element.

The scan control signal CTRY supplied to the scan driver 300 comprises a switching control signal for controlling an on/off time of an energy recovery circuit and a driving switch element within the scan driver 300. The sustain control signal CTRZ supplied to the sustain driver 400 comprises a switching control signal for controlling an on/off time of an energy recovery circuit and a driving switch element within the sustain driver 400.

The driving voltage generator 600 generates a variety of driving voltages required for the drivers 200, 300, and 400, such as a sustain voltage Vs, the scan reference voltage Vsc, the data voltage Va, and a scan voltage −Vy. The driving voltages may be varied depending on the composition of a discharge gas, the structure of a discharge cell, and/or the like.

The construction of the plasma display apparatus according to an embodiment of the present invention will be described in detail with reference the drawings.

FIG. 3 is a circuit diagram of the driver of the plasma display apparatus according to an embodiment of the present invention.

FIG. 4 is a first embodiment of a driving waveform of the plasma display apparatus according to the present invention

Referring to FIGS. 3 and 4, the driver of the plasma display apparatus according to an embodiment of the present invention comprises the scan driver 300 for supplying the driving voltage less than the first base voltage to the scan electrode Y in a subfield period, the sustain driver 400 for supplying the driving voltage less than the second base voltage to the sustain electrode Z in the subfield period, and the data driver 200 for supplying a voltage of a data pulse more than the third base voltage to the address electrode X.

In this case, the plasma display panel may be represented by an equivalent capacitor Cp1 formed between the scan electrode Y and the sustain electrode Z, an equivalent capacitor Cp2 formed between the scan electrode Y and the address electrode X, and an equivalent capacitor Cp3 formed between the sustain electrode Z and the address electrode X.

In the above-described embodiment of the present invention, for example, the first base voltage and the second base voltage may be less than or equal to the third base voltage. Furthermore, the first base voltage, the second base voltage, and the third base voltage may have the same level.

Furthermore, the subfield period refers to the period comprising the reset period, the address period, and the sustain period.

As described above, the plasma display apparatus according to an embodiment of the present invention can improve the stability of driving. Furthermore, the plasma display apparatus according to an embodiment of the present invention can minimize damage to components when the plasma display apparatus is driven and can extend the lifespan of the components accordingly. For example, by setting the voltage levels of the scan electrode Y and the sustain electrode Z more than that of the address electrode X, damage to the address electrode X (i.e., damage to phosphors) can be prevented. Accordingly, high luminance can be realized and the lifespan of the panel can be extended.

Furthermore, in the related art, if a high voltage is applied to the scan electrode Y and the sustain electrode Z to generate a discharge, an excessive discharge current flows through the equivalent capacitor Cp1 formed between the scan electrode Y and the sustain electrode Z. The excessive current flows toward the address electrode X through the equivalent capacitor Cp2 formed between the scan electrode Y and the address electrode X and the equivalent capacitor Cp3 formed between the sustain electrode Z and the address electrode X. Accordingly, the excessive current not only damages the address electrode X (i.e., phosphors), but also strikes a mortal blow to a data driving IC. In the present invention, however, the plasma display apparatus is driven at a low voltage. Accordingly, damage to not only the phosphors, but also the data driving IC of the address electrode X can be minimized and the lifespan of the plasma display apparatus can be improved.

Furthermore, such low-voltage driving may result in an enhanced driving margin and a simplified driving circuit. In addition, damage to the drivers can be minimized and the reliability of driving can be improved.

Furthermore, in a plasma display apparatus according to another embodiment of the present invention, the scan driver 300 may apply the entire driving pulses to the scan electrode Y as a negative polarity in the subfield period. The sustain driver 400 may apply the entire driving pulses, which are applied to the sustain electrode Z in the subfield period, as a negative polarity. The data driver 200 may apply a voltage of a data pulse having a positive polarity to the address electrode X.

The plasma display apparatus according to another embodiment of the present invention can improve the stability of driving. Furthermore, the plasma display apparatus according to another embodiment of the present invention can minimize damage to components when the plasma display apparatus is driven and can extend the lifespan of the components accordingly. For example, when the plasma display apparatus is driven as a negative voltage, low-voltage driving can be realized and an effect on driving circuit elements can be minimized compared with the related art in which both the positive voltage and the negative voltage are used. In addition, since elements having a low rating voltage can be used through low-voltage driving, the production cost can be saved. Furthermore, since the structures of switch elements and a voltage source can be simplified, the reliability of the circuit operation can be improved.

The driver of the plasma display apparatus according to an embodiment of the present invention will be described in detail below.

The scan driver 300 supplies the voltage of the first set-down pulse, which gradually falls from the first base voltage, to the scan electrode Y in the reset period RP, and maintains the scan reference voltage Vsc less than a first base voltage GND1 in the address period AP and then supplies a voltage of a scan pulse, which falls from the scan reference voltage Vsc, to the scan electrode Y, in the address period AP. In the sustain period, the scan driver 300 supplies the voltage of the sustain pulse to the scan electrode Y.

The scan driver 300 comprises a first set-down voltage supply unit 330, a scan voltage supply unit 340, a scan reference voltage supply unit 320, a first sustain pulse supply unit 310, and a scan integrated circuit 350.

The first set-down voltage supply unit 330 supplies the scan electrode Y with a ramp-down waveform that falls from the first base voltage to a first set-down voltage −Vset dn1 of a negative polarity at a predetermined slant.

The first set-down voltage supply unit 330 is commonly connected to the scan voltage supply unit 340 and the sustain pulse supply unit 310 in parallel at a first node N1. The first set-down voltage supply unit 330 supplies the scan electrode Y with a ramp-down waveform that falls from the first base voltage GND1 to the first set-down voltage −Vset dn1 at a predetermined slant during a predetermined period T2 of the reset period RP. The first set-down voltage supply unit 330 may comprise a first switch SW1 connected between the first node N1 and a negative voltage source of the negative set-down pulse and a first variable resistor R1 connected to a gate terminal of the first switch SW1.

The scan reference voltage supply unit 320 is connected parallel to the first set-down voltage supply unit 330 and supplies the scan electrode Y with the scan reference voltage Vsc.

The scan reference voltage supply unit 320 is connected in series to a scan integrated circuit 350 comprising switch elements SW2, SW3 at a second node N2. When the second switch SW2 is turned on, the scan reference voltage supply unit 320 supplies a scan reference voltage −Vsc less than the first base voltage GND1 to the scan electrode Y during predetermined periods T3, T5 of the address period AP through the second node N2. Alternatively, the scan reference voltage −Vsc may have a negative polarity.

The scan voltage supply unit 340 is commonly connected parallel to the first set-down voltage supply unit 330 and the scan reference voltage supply unit 320 and supplies the scan electrode Y with the scan voltage −Vy.

The scan voltage supply unit 340 is connected parallel to the first set-down voltage supply unit 330 at the first node N1. For example, the scan voltage supply unit 340 may supply a voltage of the scan pulse −Vy, which falls from the scan reference voltage −Vsc, to the scan electrode Y, during a predetermined time T4 of the address period AP. The scan voltage supply unit 340 comprises a fourth switch SW4 connected between the scan voltage source −Vy and the first node N1.

The first sustain pulse supply unit 310 is commonly connected parallel to the first set-down voltage supply unit 330 and the scan voltage supply unit 340 and supplies the scan electrode Y with the sustain pulse. For example, the first sustain pulse supply unit 310 may comprise a first base voltage supply unit 311 for supplying the first base voltage to the scan electrode Y in order to supply the sustain pulse, and a first sustain voltage supply unit 312 for supplying the sustain voltage Vs to the scan electrode Y.

The first sustain pulse supply unit 310 supplies a sustain pulse less than the first base voltage to the scan electrode Y during predetermined periods T6 to T9 of the sustain period SP. In the first embodiment of the driving waveform of the plasma display apparatus of the present invention, a sustain pulse, which rises from a voltage less than the first base voltage to the first base voltage, may be supplied to the scan electrode Y, as shown in FIG. 4. For example, a sustain pulse rising from a negative sustain voltage −Vs to the first base voltage GND1 may be supplied to the scan electrode Y. The first sustain pulse supply unit 310 comprises the first sustain voltage supply unit 312 for supplying the negative sustain voltage −Vs and the first base voltage supply unit 311 for supplying the first base voltage GND1.

The first sustain voltage supply unit 312 is connected to the first node N1 and supplies the sustain voltage −Vs to the scan electrode Y alternately with the base voltage GND1 supplied to the scan electrode Y by the first base voltage supply unit 311 during predetermined periods T6 to T9 of the sustain period. The first sustain voltage supply unit 312 comprises a fifth switch SW5 connected between a negative sustain voltage source −Vs and the first node N1.

The fifth switch SW5 electrically connects the negative sustain voltage source −Vs to the first node N1 in response to a switching control signal from the controller.

The first base voltage supply unit 311 is connected to the first node N1 and supplies the first base voltage GND1 to the scan electrode Y during the sustain period. The first base voltage supply unit 311 comprises a sixth switch SW6 connected between a base voltage source GND1, and the first node N1 (i.e., a common node of the first set-down voltage supply unit 330 and the first sustain voltage supply unit 312).

The sixth switch SW6 electrically connects the base voltage source GND1 to the first node N1 in response to a switching control signal from the controller. Accordingly, the base voltage GND1 is transferred to the first node N1 in the sustain period.

The sixth switch SW6 operates alternately with the fifth switch SW5 during the sustain period. Accordingly, in the sustain period, the base voltage GND1 and, for example, the negative sustain voltage −Vs are alternately supplied to the first node N1.

The scan integrated circuit 350 comprises a second switch SW2 and a third switch SW3, which are connected between the first node N1 and a scan reference voltage supply source −Vsc in a push-pull form. The common node N2 of the second switch SW2 and the third switch SW3 is connected to the scan electrode Y.

The second switch SW2 is connected between the scan reference voltage supply source −Vsc and the second node N2 and controls the supply of the scan reference voltage −Vsc to the scan electrode Y according to the switching control signal from the controller. The third switch SW3 is connected between the second node N2 and the first node N1. The third switch SW3 controls the supply of the first set-down voltage −Vset dn, the scan voltage −Vy, the first sustain voltage −Vs, and the first base voltage GND1 to the first set-down voltage supply unit 330, the scan voltage supply unit 340, the first sustain voltage supply unit 312, and the first base voltage supply unit 311, which are connected to the first node N1, and the scan electrode Y connected to the second node N2 according to the switching control signal from the controller.

The sustain driver 400 supplies a driving voltage less than a second base voltage GND2 to the sustain electrode Z in the subfield period. For example, the sustain driver 400 may supply a voltage of a second set-down pulse −Vset dn2, which falls from the second base voltage GND2, to the sustain electrode Z in the reset period and supply a second sustain pulse having the second base voltage GND2 or the sustain voltage −Vs less than the second base voltage GND2 to the sustain electrode Z alternately with the first sustain pulse applied to the scan electrode Y in the sustain period.

The sustain driver 400 comprises a second sustain pulse supply unit 410 and a second set-down voltage supply unit 420.

The second set-down voltage supply unit 420 supplies the sustain electrode Z with the second set-down voltage −Vset dn2 that falls from the second base voltage GND2 during a predetermined period T1 of the reset period RP. For example, the second set-down voltage −Vset dn2, which falls from the second base voltage GND2 of the ground level to a negative specific voltage, may be supplied to the sustain electrode Z.

The second set-down voltage supply unit 420 comprises a seventh switch SW7, which is connected between a second set-down voltage source −Vset dn2 and the sustain electrode Z, and a second variable resistor R2 connected to a gate terminal of the seventh switch SW7.

The seventh switch SW7 electrically connects the second set-down voltage source −Vset dn2 to the sustain electrode Z in response to the switching control signal from the controller. At this time, the second variable resistor R2 may control the slant of the second set-down voltage −Vset dn2 supplied from the second set-down voltage source −Vset dn2.

The second sustain pulse supply unit 410 supplies the second sustain pulse to the sustain electrode Z during the sustain period. In the first embodiment of the driving waveform of the plasma display apparatus of the present invention, a sustain pulse rising from a voltage less than the second base voltage to the second base voltage may be supplied to the sustain electrode Z, as shown in FIG. 4. For example, a sustain pulse rising from the negative sustain voltage −Vs to the second base voltage GND2 of the ground level may be supplied to the sustain electrode Z.

The second sustain pulse supply unit 410 comprises a second sustain voltage supply unit 412 for supplying the sustain voltage −Vs and a second base voltage supply unit 411 for supplying the second base voltage GND2.

The second sustain voltage supply unit 412 is connected to the sustain electrode Z and supplies the sustain voltage −Vs to the sustain electrode Z during the sustain period. The second sustain voltage supply unit 412 comprises an eighth switch SW8 connected between a negative sustain voltage source −Vs for supplying, for example, a negative sustain voltage, and the sustain electrode Z.

The eighth switch SW8 electrically connects the negative sustain voltage source −Vs to the sustain electrode Z according to the switching control signal supplied from the controller. Accordingly, in the sustain period, the sustain electrode Z is supplied with the negative sustain voltage −Vs.

The second base voltage supply unit 410 is connected to the sustain electrode Z and may supply the second base voltage GND2 to the sustain electrode Z during the address period. The second base voltage supply unit 410 also supplies the second base voltage GND2 to the sustain electrode Z while operating alternately with the second sustain voltage supply unit 412 during the sustain period. The second base voltage supply unit 410 comprises a ninth switch SW9 connected between a second base voltage source GND2 and the sustain electrode Z.

The ninth switch SW9 electrically connects the second base voltage source GND2 to the sustain electrode Z in response to the switching control signal supplied from the controller. The ninth switch SW9 operates alternately with the eighth switch SW8 during the sustain period. Accordingly, the second base voltage GND2 is supplied to the sustain electrode Z alternately with the negative sustain voltage −Vs.

Meanwhile, each of the switch elements SW1 to SW9 may be a Field Effect Transistor (FET) having a body diode, but not limited thereto.

The data driver 200 supplies a data voltage Va less than a third base voltage GND3 to the address electrode X. The data driver 200 comprises a third base voltage supply unit (not shown) and a data voltage supply unit (not shown), and supplies a data pulse having the third base voltage GND3 and the data voltage Va to the address electrode X during the period T4 of the address period AP. For example, the data driver 200 may supply a positive data voltage Va more than the third base voltage GND3 of the ground level to the address electrode X.

In this case, the first base voltage GND1 (i.e., a reference voltage supplied from the scan driver 300) and the second base voltage GND2 (i.e., a reference voltage supplied from the sustain driver 400) may be set less than the voltage of the data pulse Va. This is because it can minimize the influence of a current, which is generated, for example, upon discharge of the scan electrode Y and the sustain electrode Z during the sustain period SP, to the address electrode X. That is, the failure of a data IC due to excessive current flowing into the address electrode X can be prevented.

Furthermore, for example, the first base voltage GND1 and the second base voltage GND2 may be set to be less than or equal to the third base voltage GND3. In addition, the first base voltage GND1, the second base voltage GND2, and the third base voltage GND3 may have a variety of levels, including the same level such as the ground level.

As described above, the scan driver 300 and the sustain driver 400 supply the entire driving voltage supplied during the subfield period (i.e., the reset, address, and sustain periods), which are less than the data voltage supplied to the address electrode X, thereby improving the stability of driving.

Furthermore, there is advantage in that low-voltage driving can be realized since a negative driving voltage is supplied to the scan electrode Y and the sustain electrode Z. Furthermore, if the negative voltage is applied to the scan electrode Y and the sustain electrode Z as described above, positive ions having a heavy mass, of discharge gases, are moved toward the scan electrode Y and the sustain electrode Z, thereby preventing damage to phosphors on the part of the address electrode X. Accordingly, not only luminance can be improved, but also the lifespan of the panel can be extended.

Furthermore, the number of path switch elements existing in the conventional driver using both a positive voltage and a negative voltage can be reduced. This enables the use of a switch element having a low rating voltage. Accordingly, the production cost can be saved significantly.

In addition, the construction of the driver can be simplified and driving characteristics can be improved.

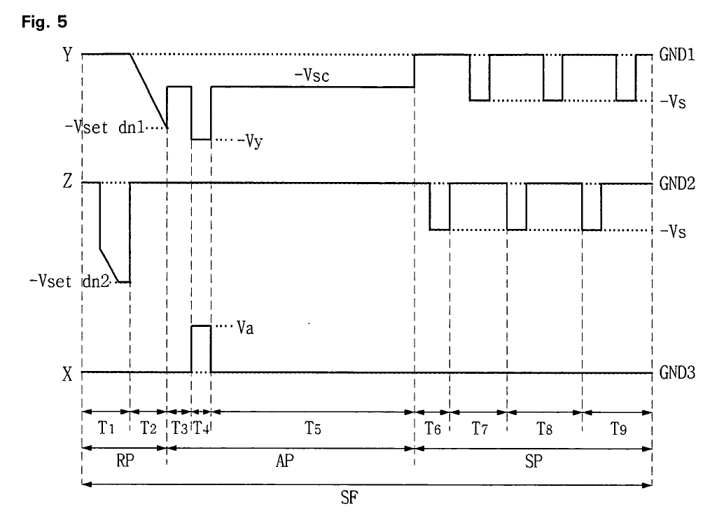

FIG. 5 illustrates a second embodiment of a driving waveform of the plasma display apparatus according to the present invention.

Referring to FIG. 5, in the driving method of the plasma display apparatus according to an embodiment of the present invention, the plasma display apparatus may be driven with a subfield being divided into the reset period RP, the address period AP, and the sustain period SP.

In the reset period RP, a voltage of a first set-down pulse −Vset dn1 that gradually falls from a first base voltage GND1 is supplied to the scan electrode Y. For example, before the first set-down pulse −Vset dn1 is supplied to the scan electrode Y, a voltage of a second set-down pulse −Vset dn2 that falls from the second base voltage GND2 may be supplied to the sustain electrode Z. The second set-down pulse may comprise a gradually falling pulse. That is, the voltage may abruptly fall from the second base voltage GND2 to a predetermined voltage level less than the second base voltage GND2 and then gradually falls to the second set-down voltage −Vset dn2.

In the address period AP, a voltage of a scan pulse −Vy that falls from a scan reference voltage −Vsc less than a first base voltage GND1 is supplied to the scan electrode Y. Furthermore, while the voltage of the scan pulse −Vy is supplied to the scan electrode Y, a voltage of a data pulse Va that rises from a third base voltage GND3 is supplied to the address electrode X.

In the sustain period SP, the scan electrode Y and the sustain electrode Z are supplied with a sustain pulse. In the second embodiment of the driving waveform of the plasma display apparatus of the present invention, the sustain pulse is controlled differently from that of the first embodiment of FIG. 4.

In more detail, a first sustain pulse falling from the first base voltage GND1 may be supplied to the scan electrode Y, and a second sustain pulse falling from the second base voltage GND2 may be supplied to the sustain electrode Z alternately with the first sustain pulse. For example, a sustain pulse that falls from the first base voltage GND1 and the second base voltage GND2, of a ground level, to a negative sustain voltage −Vs may be supplied to the scan electrode Y and the sustain electrode Z.

For example, the first base voltage GND1 and the second base voltage GND2 may be set to be less than or equal to the third base voltage GND3. Furthermore, the first base voltage GND1, the second base voltage GND2, and the third base voltage GND3 may have a variety of levels, including the same level such as the ground level.

As described above, the plasma display apparatus according to an embodiment of the present invention can be driven using a low voltage. It is therefore possible to improve driving margin. Furthermore, since the plasma display apparatus is driven considering a voltage level between the scan electrode Y, the sustain electrode Z, and the address electrode X, there are advantages in that the reliability of driving can be improved and the lifespan of the panel can be extended. It is to be understood that the present invention is not limited to the above-mentioned embodiments but may be implemented through a combination of embodiments.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus, comprising:
a plasma display panel comprising an address electrode, a scan electrode, and a sustain electrode;
a scan driver for supplying a driving voltage that is less than a first base voltage to the scan electrode in a subfield period;
a sustain driver for supplying a driving voltage that is less than a second base voltage to the sustain electrode in the subfield period; and
a data driver for supplying a voltage of a data pulse, which is more than a third base voltage, to the address electrode,
wherein the first base voltage and the second base voltage are less than the voltage of the data pulse.

2. The plasma display apparatus of claim 1, wherein the subfield period comprises a reset period, an address period, and a sustain period.

3. The plasma display apparatus of claim 1, wherein the driving voltage supplied to the scan electrode by the scan driver comprises a voltage of a first set-down pulse, which gradually falls from the first base voltage, in a reset period, a scan reference voltage maintained at a constant level in an address period, a voltage of a scan pulse, which falls from the scan reference voltage level, in the address period, and a voltage of a sustain pulse supplied in a sustain period.

4. The plasma display apparatus of claim 1, wherein the driving voltage supplied to the sustain electrode by the sustain driver comprises a second set-down voltage falling from the second base voltage in a reset period, and a sustain voltage.

5. The plasma display apparatus of claim 1, wherein the scan driver and the sustain driver alternately supply sustain pulses, the sustain pulses supplied by the scan driver fall from the first base voltage and the sustain pulses supplied by the sustain driver fall from the second base voltage, in a sustain period.

6. The plasma display apparatus of claim 1, wherein the scan driver and the sustain driver alternately supply sustain pulses, which rise from a voltage having a level less than the first base voltage and the second base voltage to the first base voltage and the second base voltage, in a sustain period.

7. The plasma display apparatus of claim 1, wherein the first base voltage and the second base voltage are less than or equal to the third base voltage.

8. The plasma display apparatus of claim 1, wherein the voltage levels of the first base voltage, the second base voltage, and the third base voltage are equal to each other.

9. A plasma display apparatus, comprising:
a plasma display panel comprising an address electrode, a scan electrode, and a sustain electrode;
a scan driver for ensuring that all of the driving pulses applied to the scan electrode in a subfield period have a negative polarity;
a sustain driver for ensuring that all of the driving pulses applied to the sustain electrode in the subfield period have a negative polarity; and
a data driver for supplying a voltage of a data pulse, which has a positive polarity, to the address electrode.

10. The plasma display apparatus of claim 9, wherein a driving voltage for supplying the negative pulse supplied to the scan electrode by the scan driver comprises a voltage of a first set-down pulse, which gradually falls from a first base voltage, in a reset period, a scan reference voltage maintained at a constant level less than the first base voltage in an address period, and a voltage of a scan pulse, which falls from the scan reference voltage level, in the address period, and
a driving voltage for supplying the negative pulse supplied to the sustain electrode by the sustain driver comprises a voltage of a second set-down pulse, which falls from a second base voltage, in the reset period.

11. The plasma display apparatus of claim 10 wherein the scan driver and the sustain driver alternately supply sustain pulses, the sustain pulses supplied by the scan driver fall from the first base voltage and the sustain pulses supplied by the sustain driver fall from the second base voltage, in a sustain period.

12. The plasma display apparatus of claim 10, wherein the scan driver and the sustain driver alternately supply sustain pulses, which rise from a voltage level less the first base voltage and the second base voltage to the first base voltage and the second base voltage, in a sustain period.

13. The plasma display apparatus of claim 10, wherein the first base voltage, the second base voltage, and the third base voltage equal a ground level voltage.

14. The plasma display apparatus of claim 10, wherein the scan driver comprises:
a first set-down voltage supply unit for supplying a ramp-down waveform, which falls from the first base voltage to a first set-down voltage of a negative polarity at a predetermined slope, to the scan electrode;
a scan voltage supply unit connected parallel to the first set-down voltage supply unit, for supplying the scan voltage to the scan electrode;
a first sustain pulse supply unit connected parallel to the first set-down voltage supply unit and the scan voltage supply unit, for supplying a sustain voltage to the scan electrode; and
a scan reference voltage supply unit connected parallel to the first set-down voltage supply unit and the scan voltage supply unit, for supplying the scan reference voltage to the scan electrode.

15. The plasma display apparatus of claim 14, wherein the first sustain pulse supply unit comprises:
a first base voltage supply unit for supplying the first base voltage to the scan electrode; and
a first sustain voltage supply unit for supplying the sustain voltage to the scan electrode.

16. The plasma display apparatus of claim 10, wherein the sustain driver comprises:
a second set-down voltage supply unit for supplying the sustain electrode with a second set-down voltage; and
a second sustain pulse supply unit connected parallel to the second set-down voltage supply unit, for supplying a sustain voltage and a second base voltage to the sustain electrode.

17. A method of driving a plasma display apparatus, comprising the steps of:
supplying a first set-down pulse gradually falling from a first base voltage and a scan pulse falling from a scan reference voltage less than the first base voltage, to a scan electrode, and supplying a sustain pulse, which falls from a first sustain base voltage which is equal to the first base voltage, or rises from a second sustain base voltage less than the scan reference voltage to the first base voltage, to the scan electrode;
supplying a second set-down pulse before the first set-down pulse is supplied to the scan electrode, which falls from a second base voltage, to the sustain electrode, and supplying a sustain pulse, which falls from the first sustain base voltage, which is equal to a second base voltage, or rises from the second sustain base voltage less than the second base voltage to the second base voltage, to the sustain electrode; and
supplying a voltage of a data pulse, which rises from a third reference voltage, to an address electrode while the scan pulse is supplied to the scan electrode.

18. The method of claim 17, wherein the second set-down pulse comprises a gradually falling pulse.

19. The method of claim 17, wherein the first base voltage and the second base voltage are less than or equal to the third base voltage.

20. The method of claim 17, wherein the first base voltage, the second base voltage, and the third base voltage equal a ground level voltage.
